(19) United States
(12) Patent Application Publication
(10) Pub. No.: US 2026/0153463 A1
(43) Pub. Date: Jun. 4, 2026

(54) VACUUM INSULATED BOMB CALORIMETER

(71) Applicant: Solid Power Operating, Inc., Louisville, CO (US)

(72) Inventors: Saalik Rauf, Louisville, CO (US); Zachary Sprecher, Louisville, CO (US)

(21) Appl. No.: 19/409,223

(22) Filed: Dec. 4, 2025

Related U.S. Application Data
(60) Provisional application No. 63/727,785, filed on Dec. 4, 2024.

(51) Int. Cl. G01N 25/28

(52) U.S. Cl. CPC G01N 25/28

(57) ABSTRACT

A method for determining enthalpy includes placing a reactive sample within a sealable vessel, sealing the sealable vessel, placing the sealable vessel within a vacuum chamber, causing a vacuum to be formed within the vacuum chamber, causing the sample to react after causing the vacuum to be formed, measuring a temperature parameter during the reaction of the sample, and determine an enthalpy via the measured temperature parameter.

### CROSS-REFERENCE TO RELATED APPLICATIONS

This application claims the benefit of and priority to U.S. Application No. 63/727,785, filed Dec. 4, 2024. The entire disclosure of the above application is incorporated herein by reference.

### TECHNICAL FIELD

Aspects of the disclosure relate to battery-type voltage sources, and more particularly to measuring energy released during an electric cell thermal runaway event, and other thermal events.

### BACKGROUND

With the ever-increasing adoption of mobile devices, electric automobiles, and the development of Internet-of-Things devices, the need for battery technologies with improved reliability, capacity (Ah), thermal characteristics, lifetime and recharge performance has never been greater. While some battery technologies offer potential increases in safety, packaging efficiency, and enable new high-energy chemistries, further improvements are needed. Instruments used to measure battery safety need to be developed alongside batteries, and current available commercial options fail to accurately measure total enthalpy during thermal runaway.

In one example, battery thermal runaway is a phenomenon that can occur when internal heating causes heat-generating reactions within the battery, leading to self-sustaining reactivity that can cause the battery to catch fire or explode. The initial heating event may be caused by unplanned or unpredicted reactions within the cell, by common abuse conditions (e.g. short circuit testing), or by external heating. Once a sufficient internal temperature is reached, an autocatalytic reaction occurs where unwanted side reactions continually produce more heat, thereby triggering additional nearby reactions. In battery packs, the rise in temperature can also affect nearby cells, causing the entire battery pack to combust.

Understanding the amount of heat generated during a thermal runaway event is crucial in identifying modifications to cell design to improve stability and safety of batteries. Accurate measurements are therefore required to produce reliable models of thermal runaway and objectively measure the safety characteristics of cells. It is with these observations in mind, among others, that aspects of the present disclosure were conceived.

### SUMMARY

In accordance with one aspect of the present disclosure, a method for determining enthalpy includes placing a reactive sample within a sealable vessel, sealing the sealable vessel, placing the sealable vessel within a vacuum chamber, causing a vacuum to be formed within the vacuum chamber, causing the sample to react after causing the vacuum to be formed, measuring a temperature parameter during the reaction of the sample, and determine an enthalpy via the measured temperature parameter.

In accordance with another aspect of the present disclosure, an apparatus includes a vacuum chamber having a vacuum formed therein, a sealed vessel positioned within the vacuum chamber and having at least one temperature sensor configured to sense a temperature of the sealed vessel, a sample positioned within the sealed vessel, a controller or devices configured to cause the sample to react, collect temperature measurement data while the sample is reacting, and determine an enthalpy based on the temperature measurement data.

In accordance with another aspect of the present disclosure, an apparatus includes a vacuum chamber, a sealable vessel positionable within the vacuum chamber, at least one temperature sensor positionable to sense a temperature to the sealable vessel, a device capable of producing thermal energy, a controller system configured to regulate the vacuum chamber to create a vacuum within the vacuum chamber, after the creation of the vacuum, regulate the device capable of producing thermal energy in a way that causes a sample to react, collect temperature measurement data while the sample is reacting, and determine an enthalpy based on the temperature measurement data.

### BRIEF DESCRIPTION OF THE DRAWINGS

The drawings illustrate embodiments presently contemplated for carrying out embodiments of the invention.

### In the Drawings:

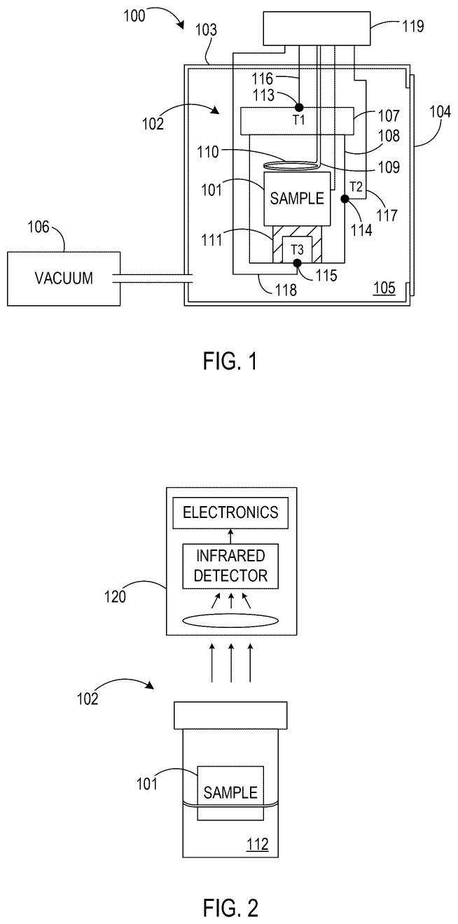

FIG. 1 is a block diagram of a bomb calorimeter according to one or more aspects of this disclosure.

FIG. 2 is a block diagram of the bomb of the bomb calorimeter of FIG. 1 according to one or more aspects of this disclosure.

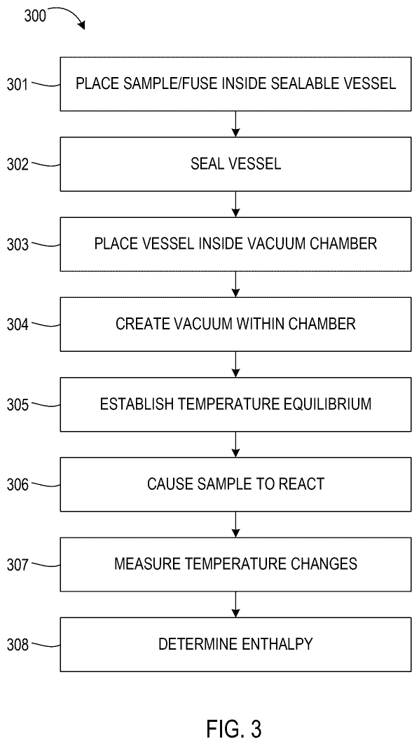

FIG. 3 is a flowchart showing a method for measuring enthalpy of a sample according to one or more aspects of this disclosure.

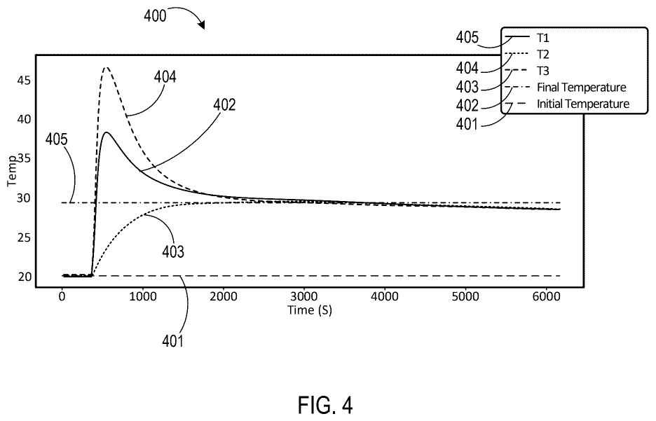

FIG. 4 illustrates an example temperature measurement plot according to one or more aspects of this disclosure.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Aspects of this disclosure relate to bomb calorimetry. Bomb calorimetry is a technique that may be used to measure the energy released by a substance. The substance may be sealed in an airtight container called a bomb, which is usually submerged in water. Although described as being airtight, in this example the gas within the vessel is not required to be air. The words airtight and “hermetically sealed” may be used interchangeably herein. Thus, as it is used herein, “airtight” is not limited to usage of air within the bomb. Further, examples herein may refer to the substance as a sample or a specimen. Such terminology is non-restrictive to the type or origin of the object or the relation of object to another object. Thus, “sample” and “specimen” may be used interchangeably herein.

In one example, one or more electrodes are positioned adjacent to the sample to cause it to react. Such reactions may include burning, combustion, oxidation, evaporation, melting, reduction, and the like. In some examples, the reactions cause a phase change to happen to some or all of the sample. The term “electrode” can be interpreted to mean ignition source, thermal device and other mechanisms that impart energy to the system. The term “burn” refers to a redox reaction that implies the chemical reaction between the various solids, liquids, or gases introduced into the chamber. In response to the reaction(s) of the sample, the energy released changes the temperature of the vessel and surrounding water, and this temperature change is used to calculate the change in heat by reaction.

FIG. 1 illustrates a block diagram of a bomb calorimeter 100 according to one or more aspects of this disclosure. A bomb calorimeter may be used in measuring the heat (e.g., from combustion) of a particular reaction and determining the total reaction enthalpy. When a sample 101 reacts inside a vessel or bomb 102 and generates heat, a temperature rise in the heat sink may be determined by the ideal equation:

$${Q}_{ideal} = {mc Δ T}_{bomb} , \qquad ( Eqn . 1 )$$

where Q_{ideal} is the heat energy, m is the mass of the bomb, C is the specific heat capacity of the bomb, and ΔT_{bomb} is the change in temperature of the bomb. However, the following equation can be used in place of the ideal equation (e.g., Eqn 1) to account for heat losses (e.g., via convection, conduction, and radiation) and the energy required to initiate reaction:

$${Q}_{measured} = {Q}_{Sample} + {Q}_{Igniter} - {Q}_{Conv .} - {Q}_{cond .} - {Q}_{rad ( out )} + {Q}_{rad ( in )} . \qquad ( Eqn . 2 )$$

The calculation of Eqn. 2 includes measuring all heat losses and accounting for them. A large source of heat loss for a bomb calorimeter is convection, which can become negligible by housing the bomb within a vacuum chamber.

The bomb calorimeter 100 of FIG. 1 provides a reduction in heat losses due to convection, conduction, and radiation. The bomb calorimeter 100 includes a sealable chamber 103 into which the bomb 102 can be placed. A door 104 or other device such as a lid allows access to the interior volume 105 of the chamber 103 for positioning the bomb 102 within the chamber 103 or removing it therefrom. A vacuum assembly 106 coupled with the interior volume 105 allows air in the interior volume 105 to be removed during testing such that a vacuum is formed in the interior volume 105, surrounding the bomb/vessel 102.

The bomb 102 includes a removable lid 107 and a vessel body 108. When attached to the vessel body 108, the lid 107 forms a hermetic seal such that no gas or other material, (e.g., ash, fire) escapes the interior of the bomb 102 during a burn reaction event. Through air and vacuum tight electrical passthroughs in the lid 107, a reaction facilitator 109 having, for example, one or more electrodes 110 can be routed such that activation of the reaction facilitator 109 in close proximity to the sample 101 causes the sample 101 to react as described herein such as, for example, combustion, burning, and other reactions. The electrode 110 may be formed of copper, tungsten, silver, carbon, gold, iridium, aluminum, or nickel, or a combination thereof in some examples. Thus, for some types of samples, the reaction facilitator 109 may be an igniter configured to cause a combustion or burning reaction in the sample. In one example, the sample 101 is an electrical battery cell, and the electrode(s) of the reaction facilitator 109 is an electronic fuse such as a heater or heating element. In other examples, the reaction facilitator 109 may itself ignite a flame to cause a corresponding reaction in the sample 101.

The lid 107 further seals the pressure within the bomb 102 during chemical reactions caused by the reactions of the sample 101. The seal ensures that no material is lost such that all generated heat remains in the bomb 102. By placing the bomb 102 in the interior volume 105 of the chamber 103 and creating a vacuum therein, heat loss from the vessel due to convection is negligible. Further, positioning the sample 101, in one example, on a support 111 with a high insulative property (e.g., polystyrene) reduces heat loss due to conduction. In another example, as illustrated in FIG. 2, the support 111 may suspend the sample 101 within an interior volume 112 of the bomb 102. The support 111 may be, for example, a wire, a cable, a rope, or other material capable of suspending the sample 101 within the bomb 102 to avoid the sample 101 physically contacting the bomb 102. The sample 101 may sit on the support 111, or the support 111 may be positioned about the bomb 102 as illustrated.

To reduce radiation losses, the vessel 102 and chamber 103 may be constructed of a same material (e.g., stainless steel) and have the same emissivity. Accordingly, when at the same temperature, the vessel 102 and chamber 103 exchange zero or negligible radiative heat. In some cases, the materials of construction may vary; however, the use of material with matching emissivity. By having a matching emissivity, two or more distinct materials of construction may exhibit the same emissivity or have emissivities sufficiently close to facilitate the exchange of zero or negligible radiative heat. In one example, at a maximum temperature of the bomb 102, the radiative heat loss may be about 9 Watts, though it should be understood that radiative heat loss my various per application. The chamber 103 may be further thermally regulated by heating or cooling the chamber 103 to a specific temperature in order to compensate for heat losses through radiation. By reducing the radiative heat losses due to convection, conduction, and radiation as described, temperature changes on the outside of the pressure vessel 102 can be sufficient to measure or capture all of the heat coming out of the cell sample 101 during thermal runaway. That is, the bomb 102 may act as the heat sink from which temperature changes are measured during the enthalpy process. As such, a plurality of temperature sensors 113, 114, 115 are placed on, coupled to, or directed to measure the temperature of the outside surface of the bomb 102, and respective lead wires 116, 117, 118 are coupled to a controller 119 for obtaining the temperature measurements. While three temperature sensors are shown, it is understood that more or fewer temperature sensors may be used. The temperature sensors 113-115 may sense temperatures of respective portions of the external surface bomb 102 through direct contact or through non-contacting technologies such as an infrared pyrometer 120 as shown in FIG. 2.

The reaction facilitator 109 is also connected to the controller 119 for igniting the sample 101. The sample 101 may also be connected to the controller 119 to perform, for example, voltage or current testing while the sample (e.g., a battery cell) is burning or otherwise reacting.

FIG. 3 is a flowchart showing a method 300 for measuring enthalpy of a sample according to one or more aspects of this disclosure. The method 300 begins at step 301 by placing a sample (e.g., the sample 101) and an electrode of the reaction facilitator 109 inside a vessel body 108. The vessel is sealed at step 302 to create a hermetic seal within the vessel to prevent pressure, molecules, and other matter from escaping the interior of the vessel. The sealed vessel is placed inside a vacuum chamber (e.g., chamber 103) at step 303, and a vacuum is formed within the chamber at step 304. For example, a vacuum having a pressure of 1×10⁻³ Torr may be formed, although more or less vacuum may be desirable.

A temperature equilibrium is allowed to be established at step 305 and sets an initial temperature used for later enthalpy calculations. The temperature equilibrium equalizes the temperature of the vessel/bomb 102 with the surroundings after vacuum is established to cause the temperature of vessel/bomb 102 to be at or near same temperature as the chamber 103 prior to measuring temperature parameters during the reaction of the sample. The sample reaction is then instigated at step 306 by the reaction facilitator 109 or some other method that may be specific to the sample (e.g., overcharge or short circuit in the case where the sample is a battery). One or more temperatures may be continually recorded at step 307 (e.g., such as via temperature sensors 113—temperature sensor 115) until a reaction threshold is met. For example, the reaction threshold may end measurement of the temperatures in response to all temperature measurements across the bomb converging within a predetermined range or converting within the predetermined range for a predetermined time. Alternatively, the reaction threshold may be solely time-based where the time is predetermined to be sufficient to allow all temperatures to converge. The temperature at which the measured temperatures converge is used as a final temperature, and the difference between the final temperature and the initial temperature is used to calculate enthalpy at step 308. FIG. 4 illustrates an example temperature measurement plot 400 according to one or more aspects of this disclosure. As shown, from an initial temperature 401, the temperature measurements 402, 403, 404 from three temperature sensors T1-T3 are plotted as they initially diverge and then converge toward the final temperature 405.

While a convergence of the separate temperature measurements 402-404 as shown in FIG. 4 is preferable, it may be experienced in some procedures where the three measurements do not converge. In this case, it is possible to gain accuracy by sacrificing some precision. In a non-limiting example, the final temperature may be deemed to be the first point at which all three temperatures are within a certain window. Due to heat loss, a wider window gives a greater measured enthalpy. A consistent length of tests will provide a lowest variability in heat loss.

Embodiments of this disclosure describe using a sealed container for bomb calorimetry of samples such as charged cells, and housing the sealed container inside a vacuum chamber eliminates and/or reduces convection losses and other heat loss pathways. In another embodiment, samples such as individual cell components such as electrode layers, separator layers, or bilayers thereof may be used. In further embodiments, the sample may be multiple cells electronically connected to form a battery. This gives total cell enthalpy in an unrestrained thermal runaway just by measuring small temperature changes. The embodiments further allow for calorimetry of charged cells of various designed and formats, capture all released energy, and doesn't quench reactions during thermal runaway. By housing a sealed bomb in a vacuum chamber and properly insulating it, no heat is lost from the pressure vessel. This makes the measurement of this large energy much simpler than it would be in other systems that use many compensations or indirect methods to measure energy instead of trying to capture and contain the total energy. Thus, repeatable, quick, and accurate measurement of cell thermal runaway is possible by using the embodiments disclosed herein.

According to embodiment of this disclosure, measuring the heat/energy generated by a battery/cell during thermal runaway (enthalpy) provides a way to make consistent and repeatable thermal runaway testing. Described herein is a simple device designed to accurately measure primarily enthalpy. All of the heat generated by a burning or reacting battery is maintained inside a pressure vessel so no material or heat is lost. To further make sure no heat is lost, the vessel is inside a vacuum chamber. This stops or, in the case where absolute vacuum is not reached, greatly reduces any air around the vessel from carrying away heat. As such, only temperature changes on the outside of the pressure vessel are needed to measure in order to measure all of the heat coming out of the cell during thermal runaway.

Embodiments of this Disclosure Allow for the Following:
Determination of enthalpy by measuring temperature of the bomb itself instead of a water/other medium jacket around the bomb
Creation of a near ideal adiabatic (no heat loss) system to house the bomb
Use of a vacuum chamber to insulate the bomb
Reduction and/or elimination of heat loss to conduction by placing the bomb on a thermally insulating material
Reduction of radiative losses by having the bomb and its surroundings emit similar amounts of radiative heat (e.g., by having similar emissivity surfaces with similar temperatures)
Use of the convergence of multiple temperature sensors across the vessel to a same value or to values within a range to determine enthalpy
Use of compensations for heat loss (e.g., using the temperature of the bomb and its surroundings to calculate radiated heat loss and add it to the measured value)
Use of a sealed vessel to eliminate “quenching” of a battery cell during thermal runaway
Use of a sealed vessel also contains the reaction completely to avoid escaped gasses or ejected material for which heat must be measured separately
Creation of an adiabatic system without the use of heaters and temperature tracking (though a heated chamber to match the bomb temperature could still be implemented)
Initiating thermal runaway in cells by use of an igniter or some other method
All energy provided by the igniter is contained within the bomb and is measured such that it can be subtracted from the total measured enthalpy during the enthalpy calculation

Variable input energy for ignition of thermal runaway is possible, because this input energy is measured it can be subtracted from the total measured energy. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. A method for determining enthalpy comprising:
placing a reactive sample within a sealable vessel;
sealing the sealable vessel;
placing the sealable vessel within a vacuum chamber;
causing a vacuum to be formed within the vacuum chamber;
causing the sample to react after causing the vacuum to be formed;
measuring a temperature parameter during the reaction of the sample; and
determine an enthalpy via the measured temperature parameter.

2. The method of claim 1, wherein causing the sample to react comprises activating an electronic fuse near the sample.

3. The method of claim 1 further comprising determining a final temperature at a convergence of temperature measurement data from a plurality of temperature sensors.

4. The method of claim 1 further comprising thermally regulating the vacuum chamber by heating or cooling the vacuum chamber to a specific temperature.

5. The method of claim 1, further comprising suspending the sealable vessel within the vacuum chamber to avoid a direct contact between the sealable vessel and the vacuum chamber.

6. The method of claim 1, wherein causing the vacuum to be formed comprises causing forming the vacuum having a pressure no greater than 1×10⁻³ Torr.

7. The method of claim 1 further comprising coupling at least one temperature sensor to an outside surface of the sealable vessel.

8. The method of claim 1 further comprising positioning at least one temperature sensor in a position to detect a temperature of an outside surface of the sealable vessel via a non-contact temperature measurement.

9. An apparatus comprising:
a vacuum chamber having a vacuum formed therein;
a sealed vessel positioned within the vacuum chamber and having at least one temperature sensor configured to sense a temperature of the sealed vessel;
a sample positioned within the sealed vessel;
a controller or devices configured to:
cause the sample to react;
collect temperature measurement data while the sample is reacting; and
determine an enthalpy based on the temperature measurement data.

10. The apparatus of claim 9, wherein the at least one temperature sensor comprising a plurality of temperature sensors positioned to sense the temperature of the sealed vessel at different positions about the sealed vessel; and
wherein the controller is configured to collect the temperature measurement data using the plurality of temperature sensors.

11. The apparatus of claim 9, wherein the vacuum chamber and the sealed vessel are constructed of materials of a same emissivity.

12. The apparatus of claim 9, where the sealed vessel is suspended in the vacuum chamber by a wire, a cable, or a rope.

13. An apparatus comprising:
a vacuum chamber;
a sealable vessel positionable within the vacuum chamber;
at least one temperature sensor positionable to sense a temperature to the sealable vessel;
a device capable of producing thermal energy;
a controller system configured to:
regulate the vacuum chamber to create a vacuum within the vacuum chamber;
after the creation of the vacuum, regulate the device capable of producing thermal energy in a way that causes a sample to react;
collect temperature measurement data while the sample is reacting; and
determine an enthalpy based on the temperature measurement data.

14. The apparatus of claim 13, further comprising a plurality of temperature sensors positioned to sense the temperature of the sealable vessel at different positions about the sealable vessel; and
wherein the controller is configured to collect the temperature measurement data using the plurality of temperature sensors.

15. The apparatus of claim 13, wherein the vacuum chamber and the sealable vessel are constructed of materials of matched emissivity.

16. The apparatus of claim 13, where the sealable vessel is suspended in the vacuum chamber such that the sealable vessel does not directly contact the vacuum chamber.

17. The apparatus of claim 13, wherein the device capable of producing thermal energy comprises an electrode.

18. The apparatus of claim 17, wherein the electrode comprises copper, tungsten, silver, carbon, gold, iridium, aluminum, or nickel.

19. The apparatus of claim 13, wherein the controller is further configured to:
after the creation of the vacuum, allow a temperature equilibrium to be established among a temperature of the vacuum chamber and a temperature of the sealable vessel.

20. The apparatus of claim 19, wherein the controller is further configured to:
determine the enthalpy based on a difference between the temperature equilibrium and a convergence of the temperature measurement data to a final temperature value.
